(19) United States
(12) Patent Application Publication
(10) Pub. No.: US 2011/0119168 A1
(43) Pub. Date: May 19, 2011

(54) Construction of Currency Strength Indices

(76) Inventors: Peter Paul Carr, New York, NY (US); Liuren Wu, Short Hills, NJ (US); Philip Scott Jonquiere Brittan, Chappaqua, NY (US); Gheis Henri Hamati, Princeton, NJ (US)

(21) Appl. No.: 12/621,004

(22) Filed: Nov. 18, 2009

(51) Int. Cl. G06Q 40/00

(52) U.S. Cl. 705/35

(57) ABSTRACT

Systems, methods, and computer program products for constructing and weighting a currency index for a currency basket. The weights of the components of the currency basket can be determined using only past statistical time series behaviors of the currency pairs.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### FIELD OF THE INVENTION

Embodiments of the invention relate to construction and updating of currency strength indices by computer implemented methods, systems including at least one computer, and computer program products. Currency strength indices have been referred to as exchange rate indices, foreign currency indices, and in other terms, and are referred to herein simply as currency indices. Such currency indices are useful for evaluating the strength of respective currencies, and/or for evaluating and/or constructing currency and/or FX based financial interests, such as currency strength exchange-traded funds (ETFs), futures, forwards, options and other derivative products on the currency indices, and other instruments.

### BACKGROUND OF THE INVENTION

Fluctuation of the exchange rate between two currencies reflects the variation in the relative strengths of the two underlying currencies. By contrast, fluctuation of a currency index reflects the strength variation of that currency against a set (or a basket) of other currencies. The purpose of constructing a currency index is to provide a measure of the strength of a particular currency (referred to as the host currency) by combining the movements of exchange rates that involves this host currency. For example, the Federal Reserve publishes a Major Currency Dollar Index based on a basket of six exchange rate pairs involving the US dollar as one leg for each pair. The index contains ten exchange rate pairs before introduction of the Euro. Various criteria may be used to select the currencies in the basket, including the amount of trade between currency-pair countries. The basket of currencies in the present Federal Reserve Major Currency Dollar Index are the Euro, British pound, Swiss franc, Canadian dollar, Swedish krona, and Australian dollar.

As an example, if the price of one currency (e.g., US dollar) in all or most other currencies in a basket is going up at the same time, one can say that the US dollar is strengthening. On the other hand, if the price of the US dollar is going up in some currencies in the basket, but going down in others, then such movements more reflect the strength or weakness of currencies in the basket than the strength of the dollar. By considering movements of the price of one currency in a basket of other currencies, one can gauge the variation in the strength of this one currency.

Depending upon the criteria used to select particular currencies and the number of currencies to be included in a currency basket, a currency index can indicate the strength or weakness of a currency on a limited basis or on a wider basis. Generally, however, fewer currencies in an index tend to make the index more volatile. Many organizations, including sovereign and central banks, private banks and private organizations (e.g., Bloomberg Finance L.P., the assignee of this application), maintain currency indices.

Currency indices are generally constructed from a weighted average of the exchange rates between a target currency and a basket of other currencies. The weights can be determined in different ways and the weighted average may be computed mathematically in different ways.

The traditional method of determining the weights applied to these exchange rates is to use the level of trade between the countries involved, following the theory that countries with the most trade between them must have the most relevant exchange rates. Many indices, including the Federal Reserve indices and indices published by many banks determine weight based on trade data.

Currency indices can be normalized against different values and generally the higher the number for a currency index, the stronger the currency. For example, the Federal Reserve Major Index is normalized against 100. Illustrating normalization, the US dollar in the Federal Reserve Major Index was at 143.9059 in March 1985, and is at 74.9911 in September 2009. The Bloomberg DXY is also normalized against 100.

Currency indices can be used, for example, as the basis for contracts that allow the holder to hedge against exposure to adverse movements in that currency or to take speculative positions on the broad future strength or weakness of the currency.

### SUMMARY OF THE INVENTION

Embodiments of the invention provide systems, methods and computer program products that are useful in the construction of currency indices. According to various embodiments of the invention, construction of a currency index comprises basing all or part of the determination of weights for the currencies in an index on a statistical approach which relies on past exchange rate data. In some embodiments, such weights are used in computing a weighted average in the construction of the currency index.

According to some embodiments, weights of currencies in the basket of currencies in a currency index are updated based on current exchange rate data.

According to some embodiments, the statistical approach employs data that is available on a current basis, e.g., daily or intraday or even “tick by tick,” or is periodically updated frequently, and a currency index based on such data can be updated as frequently, e.g., on a daily basis, unlike currency indices that are based on trade data.

According to some embodiments of the invention, a currency index is constructed based on the statistical approach and exchange rate data, and trade data is not used to weight the currencies.

According to some embodiments of the invention, the statistical approach comprises performing a principal component analysis on the historical time series currency exchange data of currency pairs of all currencies in a basket of currencies in the index to determine the weights of each of the currencies in the basket. According to some embodiments, the weights are used to compute a currency index for at least one host currency in the basket. According to some embodiments, the index value is normalized.

A system, method and computer program product in accordance with an embodiment of the invention for constructing a currency index indicating the relative strength of a host currency against a basket or set of other reference currencies comprises: retrieving from at least one storage device historical currency exchange data for all currency pairs of the currencies in the basket; performing a principal component analysis on the retrieved historical time series currency exchange data to determine the weights of each of the currencies in the set, and computing a currency index for a host currency using the weights is disclosed.

According to some embodiments, a principal component analysis comprises one or more of the following: for each of the currency pairs, generating an estimated time t conditional variance between the daily log return of each currency pair at date t using the retrieved historical data up to date t−1;

standardizing the daily return on each date by the return's conditional variance estimate;

providing a matrix of a conditional covariance estimate calculated for each of the currency pairs;

obtaining from the matrix a dominant eigenvector corresponding to a dominant eigenvalue of the matrix at time t;

constructing a weight estimate from the dominant eigenvector comprising weighting the standardized return at time t with the dominant eigenvector such that sum of each of the standardized returns for each currency in the set generates the largest conditional variance for a portfolio of the summed currencies;

aggregating the weight estimates;

generating a weight for each currency of the set by weighted-averaging of the weight estimates for each of plurality of currencies using the associated dominant eigenvalues; and

computing a currency index for a host currency using the weights.

According to some embodiments, each of the conditional covariance estimates calculated for each of the currency pairs is updated recursively on a periodic (e.g., daily) basis.

According to some embodiments, the principal component analysis comprises updating on a periodic (e.g., daily) basis the host currency index based on the periodic conditional variance estimation and the time t conditional correlation generation.

According to some embodiments, a currency index is computed as described above for each of the currencies in the set as host currencies.

It will be appreciated by those skilled in the art that the foregoing is a brief exemplary and non-limiting summary, and is not intended to be restrictive.

### BRIEF DESCRIPTION OF DRAWINGS

The invention is illustrated in the figures of the accompanying drawings, which are meant to be exemplary and not limiting, and in which like references are intended to refer to like or corresponding structure and/or functionality, etc.

FIG. 1 is a flow chart presenting a method for constructing a currency index according to an embodiment of the invention.

FIG. 2 illustrates a graph that plots the time series of the daily weights on the ten currencies for the currency indices constructed according to an embodiment of the invention.

FIG. 3 is a block diagram of a computer system for implementing embodiments of the invention.

### DETAILED DESCRIPTION

As discussed above, currency indices may be constructed by combining a a basket of exchange rates with a common host currency. In accordance with one embodiment, a currency index is constructed for each of the following ten currencies based on the exchange rate movements between them: the US dollar (USD), the euro (EUR), the British pound (GBP), the Swiss franc (CHF), the Japanese yen (JPY), the Canadian dollar (CAD), the Australian dollar (AUD), the New Zealand dollar (NZD), the Swedish Krona (SEK), and the Norwegian krone (NOK). However, it is to be understood that principles of the invention and the disclosure herein are applicable to other currency indices with more, less and/or different currencies.

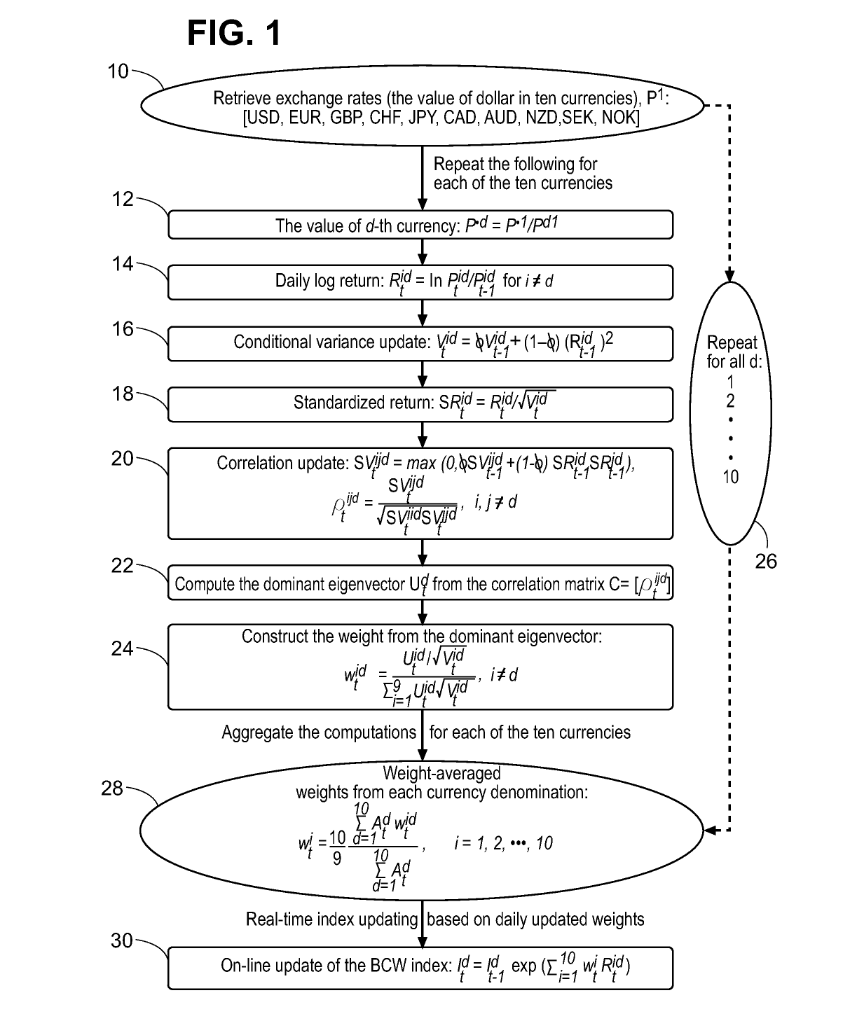

FIG. 1 depicts a flow of one embodiment for a process for constructing a currency index, e.g., for a basket of the ten currencies identified above. At each date, this analysis is performed under each of the ten currencies as the host currency, and a set of weights for the ten currencies is obtained. Then the weights on each economy computed from the ten host currencies are averaged to obtain one set of weights across all ten host currencies. As described in more detail below, the statistical method employed to determine the weights of the basket currencies in the currency index includes an implementation of a Principle Component Analysis using a sample of historical exchange rate data in an exponentially decaying window (e.g., with a half-life of 3 years).

With reference to FIG. 1, at block 10, historical data on the exchange rates of the following nine currency pairs of the dollar are retrieved by at least one computer from at least one storage device: USDEUR, USDGBP, USDCHF, USDJPY, USDCAD, USDAUD, USDNZD, USDSEK, and USDNOK. In the notation for the currency pair, the first three letters denote the host currency under consideration, and the last three letters denote the reference or numeraire currency. For example, USDEUR is the euro price of dollar. With dollar as the host currency, a US investor is understood as investing in the ten currencies. As the dollar price of dollar (USDUSD) is always one, one can think of the investor's dollar investment as the cash and the investor's investment in other nine currencies as risky investments, the risk of which is captured by the variations of the nine currency pair exchange rates. When another currency is the host, the investment in that currency becomes cash and investments in the other nine currencies become risky investments. When the US dollar is the host currency, we can denote the ten time series as,

P¹=[1, USDEUR, USDGBP, USDCHF, USDJPY, USDCAD, USDAUD, USDNZD, USDSEK, USDNOK]] (1)

where the first series is the dollar price of dollar (USDUSD), which is universally one.

At block 12, adopting any currency i as the host currency, the following transformation can be performed:

P^{d}=P¹/P^{d1}, d=1, . . . , 10. (2)

With any host currency d, the d-th column is universally one as it becomes the price of itself. Accordingly, for each host currency d, for d=1, . . . , 10, the following operation is performed, and an index on any of the currencies in the set are computed the same way by replacing the prices of dollar in the other nine currencies with the price of the host currency in the other nine currencies. Taking EUR as an example, EURUSD=1/USDEUR is set so as to obtain the dollar price of euro. Then, the other dollar currency pairs are multiplied with EURUSD to obtain the other currency prices of the euro, whereupon the data can be extended to 10 time series, and the EUREUR column is universally one as it becomes the price of itself.

At block 14, the daily log return on each currency pair is constructed:

Rₜ^{id}=ln Pₜ^{id}/Pₜ₋₁^{id}, for i≠d. (3)

Since the return on the cash position (R^{dd}) is always zero, that particular column is excluded from the calculation and in any of the following operations.

At block 16, the conditional variance of the daily log return on each currency pair at each date t is estimated. Let Vₜ^{id} denote the conditional variance on the daily return of the i-th currency pair on date t using information up to day t−1. The conditional variance is estimated and updated recursively daily according to the following equation:

Vₜ^{id}=φVₜ₋₁^{id}+(1−φ)(Rₜ₋₁^{id})², (4)

where φ controls the decay speed for past information. For example, φ can be set to φ=0.9991, corresponding to a half life of three years. To initiate the process, V₀ was set to the unconditional variance for a sample period of over nine years (e.g., from January 2000 to the present). The effect of the initial value declines gradually over time.

The conditional correlation between daily log returns of different currency pairs is estimated in block 18. Let Pₜ^{ijd} denote the time-t conditional correlation between daily returns R^{id} and R^{jd} based on information up to t−1. Given the conditional variance estimates, the return on each date is first normalized by its conditional variance estimate.

SRₜ^{id}=Rₜ^{id}/\sqrt{Vₜ^{id}}. (5)

In block 20 the following recursive estimation is performed:

SVₜ^{ijd}=max(0,φSVₜ₋₁^{ijd}+(1−φ)SVₜ₋₁^{id}SVₜ₋₁^{jd}), i,j≠d, (6)

This estimation starts with the unconditional correlation over the nine year sample as the initial value and with the same decay coefficient cp. The weights on all currency pairs in the basket are constrained to be positive, which is done by constraining the conditional covariance estimate SVₜ^{ijd} to be positive. The conditional correlation between the return pair (i, j) is given by

$${P}_{t}^{ijd} = \frac{{SV}_{t}^{ijd}}{\sqrt{{SV}_{t}^{iid}} {SV}_{t}^{jjd}} \qquad ( 7 )$$

In block 22, from the time-t conditional (9×9) correlation matrix C=[Pₜ^{ijd}], the eigenvector corresponding to the dominant (largest) eigenvalue of the matrix is estimated as follows. Let Uₜ^{id} denote the ith element of this eigenvector at time t. This eigenvector is the weight on the standardized return SRₜ such that the portfolio Σᵢ₌₁⁹SRₜ^{id}Uₜ^{id} generates the largest conditional variance. An exemplary estimate of the dominant eigenvalue A and a corresponding eigenvector U with positive components is derived through the following iterative procedure in pseudo code format:

$$U = [ \frac{1}{\sqrt{9}} ; \frac{1}{\sqrt{9}} ; … ; \frac{1}{\sqrt{9}} ] ;$$

$$sae = 10 ; maxiter = 1000 ;$$

$$tol = 5 e - 16 ; jj = 0 ;$$

while (sae>5e-16 & & jj<maxiter)

jj=jj+1; V=C·U; A=UV; Unew=V/\sqrt{sum(VV)}; sae=sum(abs(Unew−U)); U=Unew; end return{A,Unew}

In block 24, a weight is constructed from the dominant eigenvector. The weight on each of the nine currencies is given by:

$${w}_{t}^{id} = \frac{{U}_{t}^{id} / \sqrt{{V}_{t}^{id}}}{{\sum }_{i = 1}^{9} {U}_{t}^{id} / \sqrt{{V}_{t}^{id}} {SV}_{t}^{jjd}} , \\ i \neq d , \qquad ( 8 )$$

where the weights on the nine risky currency investments are normalized to sum to one. This can be regarded as full investment (zero cash) normalization by setting Wₜ^{dd}=0.

This weight can be updated at any given periodic frequency or non-periodically. For example, the weight can be updated daily based on the daily conditional variance and conditional correlation computation. The daily returns used for the weight construction can be based on currency fixings for a given time each day. For example, exemplary basket exchange rates that can be used to calculate the currency indices are the intraday Bloomberg Generic (BGN) rates for the G10 currencies, and the weights can be calculated by applying the above-described statistical method to the Bloomberg Fixing (BFIX) rates taken at 10 am eastern standard time each day, which are available on the Bloomberg Professional® Service. Where a time specific fixing is not available for the history, a last price of a given currency can be used to compute the daily return for weights construction. For example, a Bloomberg Generic (BGN) currency “Last Price” for the G10 currencies can be used.

In block 26, under each host currency the above procedure is repeated such that it produces nine weights on the other nine currencies. Performing the calculation on all ten currencies as hosts generates nine weight estimates for each of the ten host currencies. To maintain cross-sectional consistency, in block 28, the nine estimates are weight-averaged to obtain one weight for each currency:

$${w}_{t}^{i} = \frac{10}{9} \frac{{\sum }_{d = 1}^{10} {A}_{t}^{d} {w}_{t}^{id}}{{\sum }_{d = 1}^{10} {A}_{t}^{d}} , \\ i = 1 , 2 , … , 10. \qquad ( 9 )$$

It will be noted that the division is 9 instead of 10 because there is a zero weight entry for each currency as host. Accordingly, a currency index can be constructed for each of the currencies in the basket based on weights derived from the time series data. Using the operations described herein, currency indices, identified below as BCW (plus the host currency code), e.g., BCWUSD, are constructed as the cumulative investment profit and loss, ignoring interests, in investing in the ten currencies based on the daily updated weights constructed as summarized in the flow depicted in FIG. 1.

According to some embodiments, the levels of the indices are normalized to be 100 at the starting date (e.g., Jan. 4, 2000) and back-calculated to this date. Then, as shown at block 30, at any given time t, the index under each currency denomination is updated via, for example, an online interface as follows:

$${I}_{t}^{d} = {I}_{t - 1}^{d} exp ( {\sum }_{i - 1}^{10} {w}_{t}^{i} {R}_{t}^{id} ) , \qquad ( 10 )$$

where Iₜ₋₁^{d} denotes its previous updated level, Wₜⁱ denotes the prevailing weights level during the time interval and Rₜ^{id} denotes the log return on the id currency pair over the time interval [t−1, t]. It will be noted that although there are ten weights, only nine have a positive contribution because return on cash is zero, R^{dd}=0, as P^{dd}=1.

According to some embodiments, the ensuing index level during the next day is given by

$${I}_{t}^{d} = {I}_{p}^{d} {\prod }_{i = 1}^{10} {( \frac{{pid}_{t}}{{pid}_{p}} )}^{{w}_{t}^{i}} . \qquad ( 11 )$$

To make the calculation and updating more transparent, in accordance with some embodiments, let Iₚ^{d} denote the index level at the end of the each day from the start date (e.g., Jan. 4, 2000) up to the most recent date (here given as Jun. 8, 2009). According to some embodiments, data is sampled on U.S. business days and log daily returns computed on each currency pair in block 14 according to equation (3).

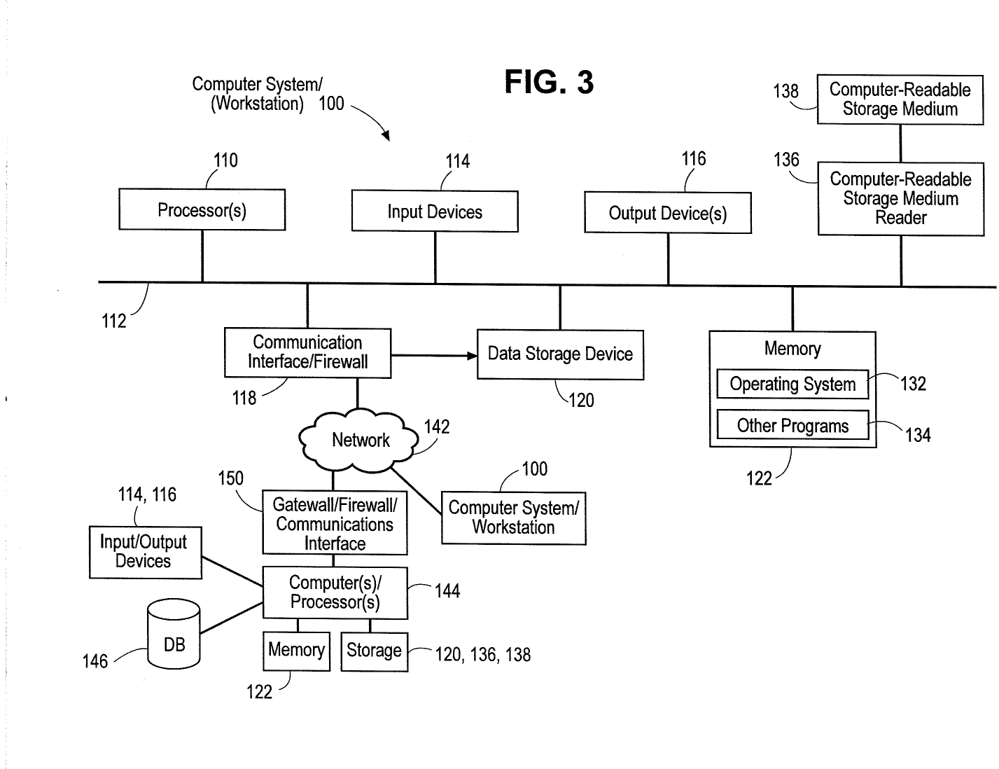

The above described currency indices are available on, for example, a workstation, described in more detail below with respect to FIG. 3, which provides for display of current intraday values, historical values, and current and historical basket weights. An official daily fixing of the indices can be published each day at a given time. New basket weights can be calculated and published every day at the given time and can be used to compute the indices starting at the same time on the following day.

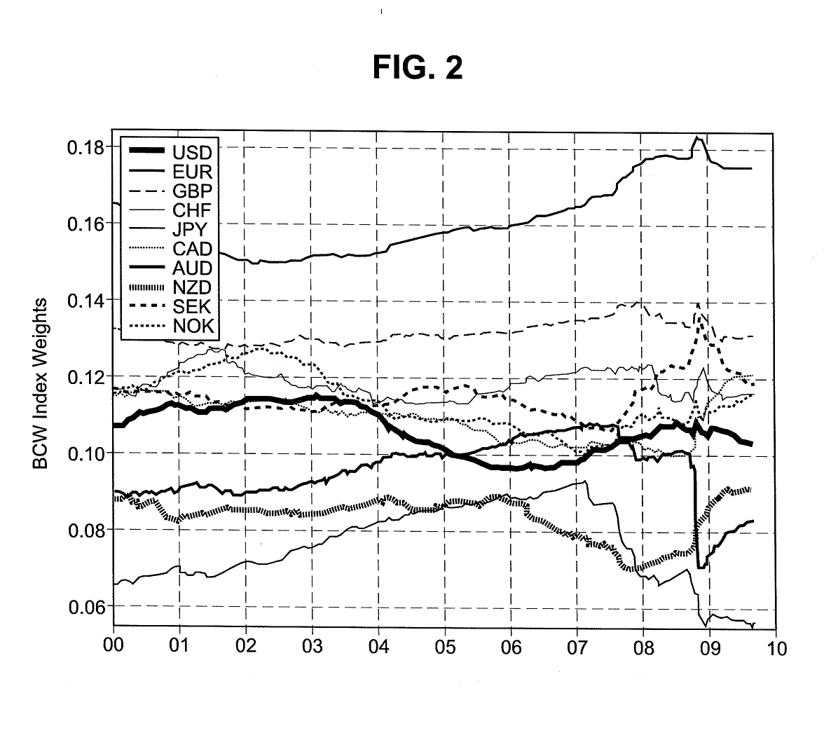

FIG. 2 plots the time series of the daily weights on the ten currencies. Time varying weights for the BCW indices. The ten lines denote the weights on the ten currencies, identified above, to construct the BCW indices in accord with the methodology described herein.

Embodiments of the invention may be implemented by systems using one or more programmable digital computers and computer readable storage media. In one embodiment, FIG. 3 depicts an example of one such computer system 100, which includes at least one processor 110, such as, e.g., an Intel or Advanced Micro Devices microprocessor, coupled to a communications channel or bus 112. The computer system 100 further includes at least one input device 114 such as, e.g., a keyboard, mouse, touch pad or screen, or other selection or pointing device, at least one output device 116 such as, e.g., an electronic display device, at least one communications interface 118, at least one computer readable medium or data storage device 120 such as a magnetic disk or an optical disk and memory 122 such as Random-Access Memory (RAM), each coupled to the communications channel 112. The communications interface 118 may be coupled to a network 142.

One skilled in the art will recognize that many variations of the system 100 are possible, e.g., the system 100 may include multiple channels or buses 112, various arrangements of storage devices 120 and memory 122, as different units or combined units, one or more computer-readable storage medium (CRSM) readers 136, such as, e.g., a magnetic disk drive, magneto-optical drive, optical disk drive, or flash drive, multiple components of a given type, e.g., processors 110, input devices 114, communications interfaces 118, etc.

In one or more embodiments, computer system 100 communicates over the network 142 with at least one computer 144, which may comprise one or more host computers and/or server computers and/or one or more other computers, e.g. computer system 100, performing host and/or server functions including web server and/or application server functions. In one or more embodiments, a database 146 is accessed by the at least one computer 144. The at least one computer 144 may include components as described for computer system 100, and other components as is well known in the computer arts. Network 142 may comprise one or more LANS, WANS, intranets, the Internet, and other networks known in the art. In one or more embodiments, computer system 100 is configured as a workstation that communicates with the at least one computer 144 over the network 142. In one or more embodiments, computer system 100 is configured as a client in a client-server system in which the at least one other computer comprises one or more servers. Additional computer systems 100, any of which may be configured as a work station and/or client computer, may communicate with the at least one computer 144 and/or another computer system 100 over the network 142.

For example, one or more databases 146 may store the historical data on exchange rates and data calculated as described herein. In various embodiments, the processing disclosed herein may be performed by computer(s)/processor(s) 144 in a host arrangement with computer system 100, or in a distributed arrangement in computer system 100 and computer(s)/processor(s) 144, or by computer system 100 in cooperation with data stored in database 146. Computer(s)/Processor(s) 144 may perform the processing disclosed herein based on computer code stored in a storage device or device(s) 120, 136, 138 and/or memory 122. Processing can be carried out using, for example, a pricing engine.

The terms “client” and “server” may describe programs and running processes instead of or in addition to their application to computer systems described above. Generally, a (software) client may consume information and/or computational services provided by a (software) server.

Various embodiments of the invention are described herein with respect to a currency index and systems related thereto. However, it is to be understood that the invention has application to other securities, derivatives and instruments that are dependent on currency indices.

While the invention has been described and illustrated with reference to certain preferred embodiments herein, other embodiments are possible. Additionally, as such, the foregoing illustrative embodiments, examples, features, advantages, and attendant advantages are not meant to be limiting of the present invention, as the invention may be practiced according to various alternative embodiments, as well as without necessarily providing, for example, one or more of the features, advantages, and attendant advantages that may be provided by the foregoing illustrative embodiments.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Except to the extent necessary or inherent in the processes themselves, no particular order to steps or stages of methods or processes described in this disclosure, including the Figures, is implied. In many cases the order of process steps may be varied, and various illustrative steps may be combined, altered, or omitted, without changing the purpose, effect or import of the methods described.

Accordingly, while the invention has been described and illustrated in connection with preferred embodiments, many variations and modifications as will be evident to those skilled in this art may be made without departing from the scope of the invention, and the invention is thus not to be limited to the precise details of methodology or construction set forth above, as such variations and modification are intended to be included within the scope of the invention. Therefore, the scope of the appended claims should not be limited to the description and illustrations of the embodiments contained herein.

What is claimed is:

1. A method for constructing a currency index indicating the relative strength of a host currency against reference currencies in a basket of currencies consisting of the host currency and the reference currencies, the method being implemented by a computer system comprising at least one data storage device in which is stored historical time currency exchange rate data for each of the currencies in the basket, at least one computer and at least one computer readable medium storing thereon computer code which when executed by the at least one computer performs the method, the method comprising the at least one computer:
retrieving from the at least one storage device historical currency exchange data for all currency pairs of the currencies in the basket relative to a value of the host currency;
performing on each of the plurality of currencies using each of the currencies as the host currency for the currency pairs, at least,
computing, for each of the currency pairs using the retrieved data, a daily log return for each of the currency pairs at date t from date t−1;
generating an estimated time t conditional variance between the daily log return of each currency pair at date t using the retrieved historical data up to date t−1;
standardizing the daily return on each date by the return's conditional variance estimate;
calculating a conditional covariance estimate for each of the currency pairs which is updated recursively;
obtaining from a matrix of the time t conditional covariance matrix a dominant eigenvector corresponding to a dominant eigenvalue of the matrix at time t;
constructing a weight estimate from the dominant eigenvector comprising weighting the standardized return at time t with the dominant eigenvector such that sum of each of the standardized returns for each currency generates the largest conditional variance for a portfolio of the summed currencies;
aggregating the weight estimates each of the plurality of currencies using each of the currencies as the host currency for the currency pairs;
generating a single weight for each currency of the set by weighted-averaging of the weight estimates for each of plurality of currencies using the associated dominant eigenvalues;
computing a currency index for a host currency using the single weight, and updating the currency index.

2. A method for constructing a currency index indicating the relative strength of a host currency against reference currencies in a basket of currencies consisting of the host currency and the reference currencies, the method being implemented by a computer system comprising at least one data storage device in which is stored historical time series currency exchange rate data for each of the currencies in the basket, at least one computer and at least one computer readable medium storing thereon computer code which when executed by the at least one computer performs the method, the method comprising the at least one computer:
retrieving from the at least one storage device historical currency exchange data for all currency pairs of the currencies in the basket;
performing principal component analysis on the retrieved historical time series currency exchange data to determine the weights of each of the currencies in the basket, and
computing a currency index for a host currency using a single weight obtained from the plurality of weights.

3. The method of claim 2, comprising computing a currency index for each of the other currencies in the basket as host currencies.

4. The method of claim 2, comprising:
for each currency index, updating the weights on a periodic basis.

5. The method of claim 2, wherein performing the principal component analysis comprises for each of the currency pairs, an operation comprising:
(a) performing, using the retrieved data, a daily log return for each of the plurality of currency pairs at date t from date t−1, excluding the currency pair where the reference currency is the host currency for the currency pairs;
(b) calculating an estimated conditional variance for each of the daily log returns at date t using the retrieved historical data up to date t−1; whereby the estimated conditional variance is updated recursively on a periodic basis
(c) generating an estimated time t conditional correlation between the daily log return of different pairs at date t using the retrieved historical data up to date t−1, wherein the generating includes:
i. standardizing the daily return on each date by the return's conditional variance estimate, and
ii. calculating a conditional covariance estimate, the conditional covariance estimate excluding the currency pairs where the reference currency is the host currency for the differing currency pairs; whereby the estimated conditional covariance is updated recursively on a periodic basis;
(d) obtaining from the time t conditional correlation matrix a dominant eigenvector corresponding to a dominant eigenvalue of the matrix at time t; and
(e) constructing a weight estimate from the dominant eigenvector, said construction including weighting the standardized return at time t with the dominant eigenvector such that sum of each of the standardized returns for each currency generates the largest conditional variance for a portfolio of the summed currencies.

6. The method of claim 5 wherein the method further includes:
performing the operation on each of the plurality of currencies using each of the currencies as the host currency for the currency pairs; and
aggregating the results of the operation performed for each of the plurality of currencies using each of the currencies as the host currency for the currency pairs.

7. The method of claim 3 wherein the method further comprises:
generating a single weight for each of the currency indices by weighted-averaging of a plurality of weight estimates obtained for each of plurality of currencies using the associated dominant eigenvalues.

8. The method of claim 7 wherein the method further comprises:
back-calculating the index to a given start date such that at any given time t, each index can be updated over the time interval [t, t−1] using the single weight.

9. The method of claim 5 wherein the method further includes:
updating the index weights on a daily basis based on the periodic conditional variance estimation and the time t conditional correlation generation.

10. A system for constructing a currency index indicating the relative strength of a host currency against reference currencies in a basket of currencies consisting of the host currency and the reference currencies, the system comprising at least one computer, at least one storage device in which is stored historical time currency exchange rate data for each of the currencies in the basket, and at least one computer readable medium storing thereon computer code which when executed by the at least one computer causes the at least one computer to at least:
retrieve from the at least one storage device historical currency exchange data for all currency pairs of the currencies in the basket relative to a value of the host currency;
perform on each of the plurality of currencies using each of the currencies as the host currency for the currency pairs, at least,
computing, for each of the currency pairs using the retrieved data, a daily log return for each of the currency pairs at date t from date t−1;
generating an estimated time t conditional variance between the daily log return of each currency pair at date t using the retrieved historical data up to date t−1;
standardizing the daily return on each date by the return's conditional variance estimate;
calculating a conditional covariance estimate for each of the currency pairs which is updated recursively;
obtaining from a matrix of the time t conditional covariance matrix a dominant eigenvector corresponding to a dominant eigenvalue of the matrix at time t; and
constructing a weight estimate from the dominant eigenvector comprising weighting the standardized return at time t with the dominant eigenvector such that sum of each of the standardized returns for each currency generates the largest conditional variance for a portfolio of the summed currencies;
aggregate the weight estimates each of the plurality of currencies using each of the currencies as the host currency for the currency pairs;
generate a single weight for each currency of the set by weighted-averaging of the weight estimates for each of plurality of currencies using the associated dominant eigenvalues;
compute a currency index for a host currency using the single weight, and update the currency index.

11. A system for constructing a currency index indicating the relative strength of a host currency against reference currencies in a basket of currencies consisting of the host currency and the reference currencies, the system comprising at least one computer, at least one storage device in which is stored historical time currency exchange rate data for each of the currencies in the basket, and at least one computer readable medium storing thereon computer code which when executed by the at least one computer causes the at least one computer to at least:
retrieve from the at least one storage device historical currency exchange data for all currency pairs of the currencies in the basket;
perform principal component analysis on the retrieved historical time series currency exchange data to determine the weights of each of the currencies in the basket, and
compute a currency index for a host currency using a single weight obtained from the plurality of weights.

12. The system of claim 11, wherein the computer includes computer code to:
compute a currency index for each of the other currencies in the basket as host currencies.

13. The system of claim 11, wherein the computer includes computer code to:
for each currency index, update the weights on a periodic basis.

14. The system of claim 11, the computer code to perform the principal component analysis comprises for each of the currency pairs, computer code to perform an operation comprising:
(a) perform, using the retrieved data, a daily log return for each of the plurality of currency pairs at date t from date t−1, excluding the currency pair where the reference currency is the host currency for the currency pairs;
(b) calculate an estimated conditional variance for each of the daily log returns at date t using the retrieved historical data up to date t−1; whereby the estimated conditional variance is updated recursively on a periodic basis
(c) generate an estimated time t conditional correlation between the daily log return of different pairs at date t using the retrieved historical data up to date t−1, wherein the generating includes:
i. standardizing the daily return on each date by the return's conditional variance estimate, and
ii. calculating a conditional covariance estimate, the conditional covariance estimate excluding the currency pairs where the reference currency is the host currency for the differing currency pairs; whereby the estimated conditional covariance is updated recursively on a periodic basis;
(d) obtain from the time t conditional correlation matrix a dominant eigenvector corresponding to a dominant eigenvalue of the matrix at time t; and
(e) construct a weight estimate from the dominant eigenvector, said construction including weighting the standardized return at time t with the dominant eigenvector such that sum of each of the standardized returns for each currency generates the largest conditional variance for a portfolio of the summed currencies.

15. The system of claim 14 wherein the system further includes computer code to:
perform the operation on each of the plurality of currencies using each of the currencies as the host currency for the currency pairs; and
aggregate the results of the operation performed for each of the plurality of currencies using each of the currencies as the host currency for the currency pairs.

16. The system of claim 12 wherein the system further includes computer code to:
generate a single weight for each of the currency indices by weighted-averaging of a plurality of weight estimates obtained for each of plurality of currencies.

17. The system of claim 16 wherein the system further includes computer code to:
back-calculate the index to a given start date such that at any given time t, each index can be updated over the time interval [t, t−1] using the single weight.

18. The system of claim 14 wherein the system further includes computer code to:
update the index weights on a daily basis based on the periodic conditional variance estimation and the time t conditional correlation generation.

19. A computer program product comprising a computer usable medium having computer readable code embodied therein for constructing a currency index indicating the relative strength of a host currency against reference currencies in a basket of currencies consisting of the host currency and the reference currencies, the computer program product comprising computer readable code configured to cause at least one computer operatively connected to at least one storage device in which is stored historical time currency exchange rate data for each of the currencies in the basket to perform a method comprising:
retrieving from the at least one storage device historical currency exchange data for all currency pairs of the currencies in the basket relative to a value of the host currency;
performing on each of the plurality of currencies using each of the currencies as the host currency for the currency pairs, at least,
computing, for each of the currency pairs using the retrieved data, a daily log return for each of the currency pairs at date t from date t−1;
generating an estimated time t conditional variance between the daily log return of each currency pair at date t using the retrieved historical data up to date t−1;
standardizing the daily return on each date by the return's conditional variance estimate;
calculating a conditional covariance estimate for each of the currency pairs which is updated recursively;
obtaining from a matrix of the time t conditional covariance matrix a dominant eigenvector corresponding to a dominant eigenvalue of the matrix at time t;
constructing a weight estimate from the dominant eigenvector comprising weighting the standardized return at time t with the dominant eigenvector such that sum of each of the standardized returns for each currency generates the largest conditional variance for a portfolio of the summed currencies;
aggregating the weight estimates each of the plurality of currencies using each of the currencies as the host currency for the currency pairs;
generating a single weight for each currency of the set by weighted-averaging of the weight estimates for each of plurality of currencies using the associated dominant eigenvalues;
computing a currency index for a host currency using the single weight, and updating the currency index.

20. A computer program product comprising a computer usable medium having computer readable code embodied therein for constructing a currency index indicating the relative strength of a host currency against reference currencies in a basket of currencies consisting of the host currency and the reference currencies, the computer program product comprising computer readable code configured to cause at least one computer operatively connected to at least one storage device in which is stored historical time currency exchange rate data for each of the currencies in the basket to perform a method comprising:
retrieving from the at least one storage device historical currency exchange data for all currency pairs of the currencies in the basket;
performing principal component analysis on the retrieved historical time series currency exchange data to determine the weights of each of the currencies in the basket, and
computing a currency index for a host currency using a single weight obtained from the plurality of weights.

21. The product of claim 20, comprising computer readable code configured to perform the method further comprising
computing a currency index for each of the other currencies in the basket as host currencies.

22. The product of claim 20, comprising computer readable code configured to perform the method further comprising:
for each currency index, updating the weights on a periodic basis.

23. The product of claim 20, comprising computer readable code configured to perform the principal component analysis for each of the currency pairs, including an operation comprising:
(a) performing, using the retrieved data, a daily log return for each of the plurality of currency pairs at date t from date t−1, excluding the currency pair where the reference currency is the host currency for the currency pairs;
(b) calculating an estimated conditional variance for each of the daily log returns at date t using the retrieved historical data up to date t−1; whereby the estimated conditional variance is updated recursively on a periodic basis
(c) generating an estimated time t conditional correlation between the daily log return of different pairs at date t using the retrieved historical data up to date t−1, wherein the generating includes:
i. standardizing the daily return on each date by the return's conditional variance estimate, and
ii. calculating a conditional covariance estimate, the conditional covariance estimate excluding the currency pairs where the reference currency is the host currency for the differing currency pairs; whereby the estimated conditional covariance is updated recursively on a periodic basis;
(d) obtaining from the time t conditional correlation matrix a dominant eigenvector corresponding to a dominant eigenvalue of the matrix at time t; and
(e) constructing a weight estimate from the dominant eigenvector, said construction including weighting the standardized return at time t with the dominant eigenvector such that sum of each of the standardized returns for each currency generates the largest conditional variance for a portfolio of the summed currencies.

24. The product of claim 23, comprising computer readable code configured to perform the method further comprising:
performing the operation on each of the plurality of currencies using each of the currencies as the host currency for the currency pairs; and
aggregating the results of the operation performed for each of the plurality of currencies using each of the currencies as the host currency for the currency pairs.

25. The product of claim 21, comprising computer readable code configured to perform the method further comprising:
generating a single weight for each of the currency indices by weighted-averaging of a plurality of weight estimates obtained for each of plurality of currencies.

26. The product of claim 25, comprising computer readable code configured to perform the method further comprising:
back-calculating the index to a given start date such that at any given time t, each index can be updated over the time interval [t, t−1] using the single weight.

27. The product of claim 23, comprising computer readable code configured to perform the method further comprising:
updating the index weights on a daily basis based on the periodic conditional variance estimation and the time t conditional correlation generation.
